(19) United States
(12) Patent Application Publication
(10) Pub. No.: US 2014/0370834 A1
(43) Pub. Date: Dec. 18, 2014

(54) DISABLE OF SUPPLEMENTARY SERVICE ON EMERGENCY IN IMS NETWORK

(71) Applicant: Rogers Communications Inc., Toronto (CA)

(72) Inventors: Man-Yee LIU, Milton (CA); Michael FRUMOVITCH, Vaughan (CA); Wing Chi LEUNG, Mississauga (CA); Tenio Mihaylov MIHAYLOV, Vaughan (CA)

(21) Appl. No.: 13/917,807

(22) Filed: Jun. 14, 2013

(51) Int. Cl. H04W 4/22

(52) U.S. Cl. CPC H04W 4/22
USPC 455/404.1

(57) ABSTRACT

Methods and systems for disabling supplementary services that interfere with callback from a public safety answering point are described. In one embodiment, a method is performed by a system operating in a home network domain of a wireless network. The home network domain includes a home subscriber server (HSS) which maintains user profiles associated with a plurality of communication devices. The user profiles define services enabled for such communication devices. The method includes: detecting an emergency registration associated with an emergency call placed from the communication device; and in response to detecting the emergency registration associated with the emergency call, updating, at the HSS, the user profile associated with the communication device which placed the emergency call to disable at least one supplementary service for that communication device.

### TECHNICAL FIELD

The present disclosure relates to Internet Protocol Multimedia Subsystem (IMS) networks and, more particularly, to methods of disabling a supplementary service that may interfere with a call-back during an emergency.

### BACKGROUND

Communication networks, such as wireless telecommunication networks, are sometimes required to support the handling of emergency calls. That is, such communication networks often link a mobile communication device, such as a smartphone, with one or more public safety answering points (PSAP) when an emergency call is placed by the mobile communication device. For example, in North America, dialing 911 may link the mobile communication device with a PSAP. The PSAP is a call center which accepts such emergency calls and which may route assistance services, such as ambulance, fire or police services, to a location associated with the caller.

In some situations, an emergency call may become disconnected. That is, the PSAP and the mobile communication device may lose their connection. In such a circumstance, the PSAP may attempt to call back the mobile communication device which placed the emergency call. The efforts of the PSAP to call back the mobile communication device may be complicated if the mobile communication device has enabled a supplementary service such as call forwarding or call blocking. For example, if the mobile communication device has enabled call forwarding to another device, the call may be routed to the other device instead of to the mobile communication device.

Various methods have been proposed to prevent such supplementary services from interfering with emergency calls. Many of these methods require an emergency call-back call to be specially marked as an emergency call. This requires modification at both the PSAP (which must mark emergency calls) and at the communication network (which must support such a mark and transparently relay it to a service execution point with the goal of providing special “emergency” treatment).

Furthermore, many of the previously proposed methods were not designed to work in a roaming scenario. That is, many of these methods would fail if the emergency call were placed while the mobile communication device was outside of their home network.

### BRIEF DESCRIPTION OF THE DRAWINGS

Reference will now be made, by way of example, to the accompanying drawings which show example embodiments of the present application and in which:

FIG. 1 is a block diagram of an example wireless network in accordance with example embodiments of the present disclosure;

FIG. 2 is a block diagram of an example system which may operate in a home network domain in accordance with example embodiments of the present disclosure;

FIG. 3 is a flowchart of an example method of disabling a supplementary service when an emergency call is placed;

FIG. 4 is a signal diagram illustrating the modification of a user profile in response to emergency registration detection;

FIG. 5 is a signal diagram illustrating emergency call setup; and

FIG. 6 is a signal diagram illustrating callback from a public safety answering point.

Like reference numerals are used in the drawings to denote like elements and components.

### DETAILED DESCRIPTION OF EXAMPLE EMBODIMENTS

In one aspect, disclosed is a method performed by a system operating in a home network domain of a wireless network. The home network domain includes a home subscriber server (HSS) which maintains user profiles associated with a plurality of communication devices. The user profiles define services enabled for such communication devices. The method includes: detecting an emergency registration associated with an emergency call placed from the communication device; and in response to detecting the emergency registration associated with the emergency call, updating, at the HSS, the user profile associated with the communication device which placed the emergency call to disable at least one supplementary service for that communication device.

In another aspect, a system for disabling one or more supplementary services to allow call-back to a communication device associated with an emergency is described. The system includes one or more communication subsystems enabling the system to receive communications from other systems and at least one processor coupled with the communication subsystem. The system also includes at least one memory coupled with the processor. The at least one memory stores processor executable instructions which, when executed, causes the at least one processor to: detect an emergency registration associated with an emergency call placed from the communication device; and in response to detecting the emergency registration associated with the emergency call, updating at a home subscriber server (HSS), the user profile associated with the communication device which placed the emergency call to disable at least one supplementary service for that communication device.

Other example embodiments of the present disclosure will be apparent to those of ordinary skill in the art from a review of the following detailed description in conjunction with the drawings.

### Example Network

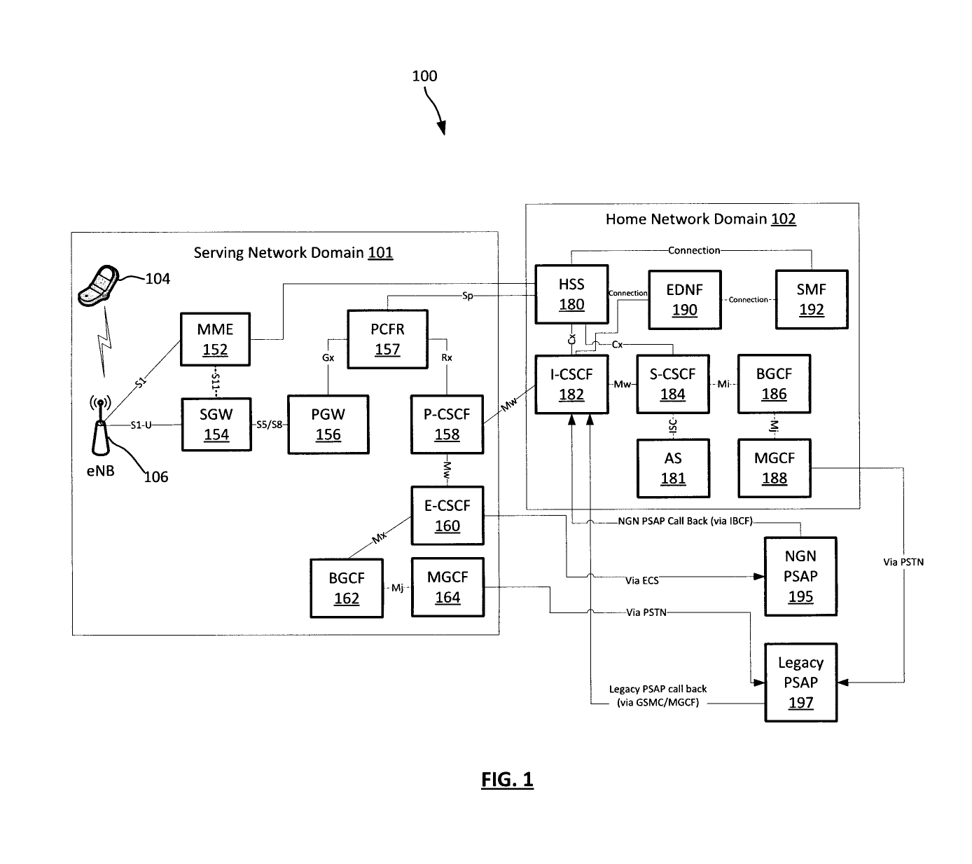

FIG. 1 is a block diagram of an example network 100. The network 100 includes IP multimedia subsystem (IMS) components and radio network components. Thus, the network may be considered to be an IMS network. The network 100 is, in the example illustrated, a wireless network which provides wireless communication services to a plurality of user equipment (UE) 104. For example, the network 100 may provide voice communication services to user equipment 104 operating within a coverage area provided by the network 100. That is, the network 100 may allow the user equipment 104 to engage in voice-based communications, such as telephone calls, with other devices such as other smartphones, mobile phone, or landline-based telephones.

In at least some embodiments, the network 100 may provide data communication services to the user equipment 104. For example, the network 100 may allow user equipment 104 to send to and/or receive data from other devices or systems such as other user equipment 104 or servers. For example, the network 100 may, in at least some embodiments, provide access to one or more public or private networks such as, for example, the Internet.

Since the network 100 provides communication services to the user equipment 104, the UE 104 may also be referred to as communication devices. The user equipment 104 that operates within the network 100 may take any one of a number of different forms. By way of example, the user equipment 104 may include smartphones, tablets, modems, computing devices, or user equipment 104 of another type. In at least some embodiments, the UE 104 may be a mobile communication device. That is, the UE may be capable of communications (i.e. via the network 100) and may also be small enough to be easily moved. In at least some embodiments, the UE is a handheld electronic device. That is, the UE is configured to be held in the palm of a user's hand. The user equipment (UE) may, for example, include mobile communication devices such as smartphones and non-smart cellular phones. The user equipment (UE) is configured to use Internet Protocol (IP) and to run Session Initiation Protocol (SIP) based user agents.

The exemplary wireless network is a network that is configured to operate according to a 3rd Generation Partnership Project (3GPP) standard. 3GPP is a wireless industry standards organization that develops and maintains wireless network access technologies. In the example shown, the network 100 is an LTE network. In at least some embodiments, the network 100 is configured to operate using a 3GPP TS 23.167 release 11 specification, or a variation or evolution thereof. It will be appreciated, however, that the network 100 may take other forms in other embodiments.

The example network 100 is an orthogonal frequency division multiplexing (OFDM) based network 100. The OFDM-based network 100 is, in at least some embodiments, a long-term evolution (LTE) network (which may also be referred to as a 4G LTE network 100). LTE is a standard for wireless communication of high-speed data to user equipment (UE) 104. The architecture of the example wireless network may be a System Architecture Evolution (SAE)-based architecture. An SAE-based architecture is one that uses the core network architecture of the 3GPP LTE wireless communication standard.

The network 100 includes components which structured according to an IP multimedia subsystem (IMS) architecture. Thus, the network 100 includes an IMS core, which is the control component of the network 100. The IMS core includes a number of components which will be discussed in greater detail below, including a home subscriber server (HSS) 180, call session control functions (CSCF), and one or more application servers (AS) 181. The IMS core may include other functions and components not specifically identified herein.

The network 100 includes a serving network domain 101 and a home network domain 102. The serving network domain 101 (which may also be referred to as the serving network) refers to the portion of the network 100 which is connected to the access network currently providing access to a user equipment 104. In the example illustrated, the serving network domain 101 is associated with a node 106 through which the UE is provided wireless communications. The serving network domain 101 is responsible for switching and routing call and packets. In order to do so, the serving network domain 101 may communicate with the home network domain 102 (also referred to as the home network) to obtain subscriber information.

Thus, the home network domain 102 functions to track user profiles for subscribers of the home network. As will be described in greater detail below, the user profile may define services that are enabled for UE 104. Accordingly, the home network performs functions that are independent of the location of the user. It is responsible for the management of subscription information for the user.

In some circumstances (e.g. when the UE is not roaming) the serving network may be operated by the operator of the home network. That is, the UE 104 may be located in a region where it communicates with a node 106 that is associated with the home network for that UE 104. However, in other circumstances (e.g. when the UE is roaming), the serving network may be operated by an operator which does not operate the home network for the UE 104. That is, the UE 104 may be communicating using a serving network that is not the same network as the home network for that UE. For example, a roaming partner may operate the serving network.

The network 100 includes a radio access network which, in the example illustrated, is an Evolved Universal Mobile Telecommunications System (UMTS) Terrestrial Radio Access Network, which may be abbreviated as E-UTRAN.

The network 100 includes a plurality of nodes 106 within the radio access network. These nodes provide access to the network 100 and are accessed depending on the location of the UE. Thus, the nodes 106 are associated with the serving network domain 101.

These nodes 106 are, in at least some embodiments, Evolved Node B nodes 106, which may also be referred to as Evolved Universal Terrestrial Radio Access (e-UTRAN) Node B nodes 106. Evolved Node B is sometimes abbreviated as eNodeB or eNB and is referred to as eNB in the example network 100 of FIG. 1. The nodes 106 are hardware components which are connected with the mobile phone network that communicates with the user equipment 104. The nodes 106 may also be referred to as access points or base stations.

The network 100 may include multiple nodes 106, even though only a single node is illustrated in the example. The number of nodes that are required will depend on the coverage area of the network 100, the number of user equipment 104 devices operating in the network 100 and the quantity of bandwidth expected to be consumed by such user equipment 104. The nodes 106 may have differing coverage areas so that when a user equipment 104 is located at a given location, it may communicate with one of the nodes 106 but may be outside of the coverage area of at least one other of the nodes 106.

The nodes 106 are communicably connected to one another. In some embodiments, an X2 interface exists between the nodes 106. This interface is a direct communication link between the nodes 106. This interface may be used to handle control plane and user plane traffic. For example, it may be used during handover (e.g. as the user equipment 104 travels from an area in which it communicates with one node 106 to an area where it communicates with a different node 106).

The network 100 includes other components which may, for example, facilitate communications with the Internet or with telephones connected to a public switched telephone network. In the example illustrated, the nodes 106 are connected to a Mobility Management Entity (MME) 152, which is included in the serving network domain 101. The MME 152 is a control node for the network 100. In at least some embodiments, the MME 152 is responsible for tracking user equipment 104. The MME 152 may also, in at least some embodiments, authenticate user equipment 104. The MME 152 may provide other functions apart from those discussed herein.

The network 100 also includes one or more gateways, located in the serving network domain 101. In the example illustrated, a Serving Gateway (SGW) 154 is illustrated. The SGW 154 may, among other things, forward and route user data packets. The SGW is, in the example illustrated, connected to a Packet Data Network Gateway (PGW or PDNGW) 156. The PGW 156 provides connectivity from the user equipment 104 to external packet networks and acts as a point of exit and entry of traffic for the user equipment 104. For example, the PGW may connect to the Internet and may provide the user equipment 104 with access to the Internet.

The network 100 includes a plurality of call session control function (CSCF). These functions are provided on one or more Session Initiation Protocol (SIP) servers or proxies and are used to process SIP signalling packets. More particularly, a Proxy CSCF (P-CSCF) 158 is provided in the serving network domain 101 and acts as the first point of contact for user equipment (UE) 104, such as mobile communication devices. The P-CSCF 158 is a SIP proxy and is located in the serving network domain 101. The P-CSCF is the first point of contact when a user equipment (UE) 104 wishes to access an IP Multimedia Subsystem (IMS) network 100. The P-CSCF is responsible for SIP message processing and may perform functions such as security and compression and policy-related functions.

The P-CSCF 158 connects to the PGW 156 via a policy charging and rules function (PCRF) 157. The PCRF 157 is a software node that is designed to determine policy rules in the network 100.

An Interrogating-CSCF (I-CSCF) 182 is a further SIP function provided in the network 100 and, more particularly, in the home network domain 102. The I-CSCF 182 has an IP address that is published in a domain name system (DNS) to allow other servers (such as a server associated with the P-CSCF 158) to find it and to forward SIP packets to the domain associated with the I-CSCF 182. That is, the I-CSCF 182 acts as an access point for the home network domain 102. It allows systems associated with another domain, such as a serving network domain 101 which is associated with a visiting network (i.e. a network in which the UE 104 is roaming), to access the home network domain 102 that provides subscriber services to that UE 104. The I-CSCF 182 forwards SIP requests or responses to a serving-CSCF (S-CSCF) 184 (and is, therefore, coupled with the S-CSCF). Accordingly, the I-CSCF is used to allow for communications between different mobile network operators.

A serving-CSCF (S-CSCF) 184 is also located in the home network domain 102. The S-CSCF is a SIP server that acts as a central node of the signalling plane. The S-CSCF 184 may be connected to the Home Subscriber Server (HSS) 180 using Cx and Dx interfaces that are based on the Diameter protocol. Diameter is an authentication, authorization and accounting protocol for computer networks. The connection to the HSS 180 allows the S-CSCF 184 to download user profiles associated with UE 104 (such as mobile communication devices) and their users.

A user profile is a collection of user-specific information that is stored in the HSS 180 and downloaded to the S-CSCF when the S-CSCF 184 needs to execute services for a registered or unregistered user. A single user profile contains a single service profile and other information. The service profile contains initial filter criteria (IFC) and other information. The IFC describe SIP message routing flow to one or more application servers. That is, the IFC in a user profile for a given UE 104 defines the specific application server(s) that will be engaged for communications to that user.

The S-CSCF 184 may perform additional functions such as, for example, handling SIP registrations allowing an IP address associated with a UE 104 to be bound with a SIP address. The S-CSCF 184 is also configured to enforce policies of the network operator, provide routing services, and to determine which application server(s) (AS) 181 a SIP message will be forwarded to in order to provide services.

While a single S-CSCF 184 is illustrated, there may be multiple S-CSCFs in some embodiments. This may, for example, allow for load distribution (e.g. to handle a greater number of SIP registrations, routing, etc.) and to avoid downtime and outages (i.e. to provide high availability).

The S-CSCF 184 acts as a SIP router by determining whether a SIP message needs to be sent to one or more application servers (AS) 181. Such routing may be performed based on the service-triggering information which is coded as IFC and stored in the user profile for the recipient of the SIP message. More particularly, the IFC in a user profile define whether a particular application server (AS) 181 will be engaged. That is, the S-CSCF is configured to selectively forward at least some messages to application servers (AS) 181 based on the user profile for a user (i.e. based on the IFC). For example, if the user profile for a user indicates that the user subscribes to call forwarding and that the user has established a number to which calls are to be forwarded, the S-CSCF may forward a SIP message to an application server (AS) 181 which implements such call forwarding. If the user does not have such call forwarding configured (i.e. if the IFC for in the user profile for that user does not include an AS 181 that implements call forwarding), then the SIP message may not be forwarded to the application server 181 which implements the call forwarding.

Thus, one or more application server(s) 181 are provided in the home network domain 102 and are coupled with the S-CSCF 184 to enable the services and features that are to be provided to a user. Such application server(s) 181 may, for example, implement call forwarding, voice mail, conferencing, forward-on-busy, call blocking, etc. Physically, an AS 181 may be comprised of a processor and associated memory and a communication subsystem which allows the application server to communicate with other systems or functions, such as the S-CSCF 184.

As noted above, the network 100 includes a home subscriber server (HSS) 180, which operates in the home network domain 102. The HSS 180 is a user profile database. More particularly, the HSS acts as the master database for a given user. That is, the HSS include user profiles for a plurality of subscribers (who may also be referred to as users). In order to store such user profiles, the HSS has memory associated therewith upon which the user profiles are stored.

A user profile includes various information and may, in at least some embodiments, include identification information (such as, for example, the subscriber's phone number(s)), security information (such as one or more security keys associated with the subscriber), subscription registration information (such as a name, address or other personal information associated with the subscriber), and/or an identification of subscribed services for the subscriber (e.g. whether the subscriber has access to supplementary services such as text messaging, data services including an Internet service, call forwarding and/or call blocking, etc.).

Accordingly, a user profile for a subscriber defines one or more services that are enabled for use with communication devices (also known as UE 104) for that subscriber. More particularly, a single user profile contains a single service profile and other information. The service profile may be divided into parts including: 1) public identifies; 2) core network service authorization; 3) IFC; and 4) shared IFC set. The IFC are initial filter criteria are used for the routing of SIP messages. More particularly, the IFC define whether a message will be routed to an application server. That is, the IFC may include a uniform resource identifier (URI) for an AS that is to be engaged (i.e. where a SIP message is to be forwarded). If the URI for the AS is not included in the IFC, then that AS is not engaged.

The shared IFC denotes an IFC which, due to common use for a large number of subscribers, is only referenced in the user profile and provisioned on a different path between the HSS and the S-CSCF.

Thus, the user profile may identify the specific application server 181 or application servers which are to be engaged by the S-CSCF 184 in order to provide the services that the subscriber is registered to use and/or that the subscriber has opted to use. For example, to implement call forwarding for a particular user, the user profile for that user may identify an application 181 server which is to be used to implement the call forwarding and may identify a number to which calls are to be forwarded. The user profile for a user is provided to the S-CSCF 184 when the S-CSCF 184 receives a SIP message associated with that user and the S-CSCF 184 uses it in order to determine how to deal with the SIP message. More particularly, application server(s) 181 are engaged based on the user profile. If the user profile indicates that a particular supplementary service (such as call forwarding) is not enabled for the user, then the S-CSCF 184 will not engage the AS 181 that implements that supplementary service (e.g. the “call forwarding” application server 181 is not engaged). More particularly, if the user profile includes IFC which do not reference an AS 181 that implements a particular supplementary service, then that supplementary service is not performed for messages directed to the UE 104 associated with the user profile.

The HSS 180 may have one or more interfaces associated therewith which allow other systems, devices or functions to connect to the HSS. For example, the HSS may include Cx and Sh interfaces. These interfaces are built upon the Diameter standard. Cx and Sh define both the protocol for communicating with the HSS and the data that is stored on the HSS.

The network 100 also includes one or more breakout gateway control functions (BGCF) 162, 186 and one or more media gateway control functions (MGCF) 164, 188. In the example embodiment, both the serving network domain 101 and the home network domain 102 include both a BGCF 162, 186 and an MGCF 164, 188. The BGCF processes requests for routing from an S-CSCF when the S-CSCF determines that a session cannot be routed using DNS (domain name system) or ENUM/DNS (ENUM is a standard also referred to as the E.164 Number mapping standard). More particularly, it provides functionality that is based on a telephone number. In the example illustrated, the BGCFs 162, 186 may be used to provide access to a device (such as a legacy PSAP 197) connected to the Public Switched Telephone Network (PSTN). That is, if the S-CSCF 184 or the E-CSCF 160 (which will be discussed below) determine that a call is to be routed via the PSTN, then the associated BGCF 162, 186 may be engaged.

The MGCFs 164, 188 are connected to the BGCFs 162, 186 for the respective domain in which the MGCF 164, 188 operates. The MGCFs are SIP endpoints. They control a media gateway and provide protocol conversion if needed.

The network 100 allows for the handling of emergency calls. An emergency call is a special type of call that is placed from the UE 104 which may be placed in an emergency. The network 100 may specially handle emergency calls. That is, a call which is marked as an emergency call which originates from a UE may be treated differently than another call which is not marked as an emergency call. The emergency call may be directed to an appropriate PSAP 195, 197.

The network 100 includes a special CSCF which handles such emergency calls. More particularly, an emergency CSCF (E-CSCF) 160 may be provided in the serving network domain 101 and may be coupled with the P-CSCF 158. The E-CSCF 160 handles certain aspects of emergency sessions. The primary task of the E-CSCF is to route emergency calls to a correct public safety answering point (PSAP).

The correct PSAP may be selected, by the E-CSCF 160, based on location information that may be included in a request for emergency registration sent from the user equipment (UE) 104, which specifies the network location and/or the geographic location of the user equipment (UE). The E-CSCF 160 may, in at least some embodiments, interact with a Location Retrieval Function (LRF) (not shown) to identify the location of the UE 104. In some embodiments, the type of emergency may also be considered by the E-CSCF when selecting the correct Public Safety Answering Point (PSAP) for routing the emergency call.

Since the P-CSCF 158 is the first point of contact for a call from the UE 104, the P-CSCF 158 detects a request for emergency registration when such an emergency request is sent from a UE and forwards the request to the emergency CSCF (E-CSCF) 160, which engages an appropriate PSAP 195, 197.

The method by which the E-CSCF 160 engages the PSAP may differ depending on whether the PSAP is a legacy PSAP 197 or whether the PSAP is a next generation (NGN) PSAP 195. The E-CSCF 160 may communicate more directly with an NGN PSAP 195 than with a legacy PSAP 197. More particularly, a legacy PSAP 195 operates over the PSTN. Accordingly, the call is routed via the PSTN. In order to route the call, the E-CSCF 160 may engage the BGCF 162 and the MGCF 164.

A NGN PSAP 195 is a PSAP that is associated with a special server, which may be referred to as an Emergency Call Service (ECS), which manages routing calls. More particularly, the call may be routed to the NGN PSAP 195 without engaging the PSTN.

The PSAPs 195, 197 may be coupled with the I-CSCF 182, which may be used to call back the UE 104 which placed an emergency call if the emergency call is disconnected. That is, if an emergency call between the UE 104 and the PSAP is disconnected, the PSAP may attempt to call back the UE, at which point the I-CSCF 182 of the home network domain 102 is engaged.

In some systems, when the PSAP attempts to call back the UE, the call may not reach the UE due to the use of a supplementary service, such as call forwarding or call blocking. In order to prevent such supplementary services from interfering with the call, the home network domain 102 may include one or more systems which are configured to disable such supplementary services for a UE 104 for at least a period of time after an emergency call is placed from that UE 104.

More particularly, an emergency detection and notification function (EDNF) 190 is provided in the home network domain 102. The emergency detection and notification function 190 may be connected with the I-CSCF 182 (in other embodiments, the EDNF 190 and the I-CSCF 182 may be integrated into a common system). As will be described in greater detail below, when an emergency registration is received in the serving network domain 101 from a UE 104, the serving network domain 101 may notify the home network domain 102 that the emergency registration has been received. This emergency registration may, for example, be sent from the P-CSCF 158 of the serving network domain 101 to the I-CSCF 182 of the home network domain 102.

The emergency registration may then be provided from the I-CSCF 182 to the EDNF 190. In at least some embodiments, the EDNF 190 may be built into the I-CSCF 182. More particularly, the EDNF 190 and the I-CSCF 182 may be provided on a common system and, in at least some embodiments, implemented using a common processor. The EDNF 190 is used to extend emergency registration notification to a services modification function (SMF) 192. More particularly, I-CSCFs 182 may be configured to forward the emergency registration to the S-CSCF, but do not allow for forwarding to another system such as the SMF 192. Accordingly, the EDNF 190 may be provided together with the I-CSCF 182 so that the SMF 192 is notified of an emergency registration. That is, the EDNF 190 detects the emergency registration for the UE and, in response, sends a notification to a services modification function (SMF) 192.

The SMF 192 receives the message from the EDNF 190. The message informs the SMF 192 that a specific UE 104 (which may be identified in the message) has sent an emergency registration to the network 100. In response to receiving this message, the SMF 192 initiates a timer (which is associated with the UE) and updates the user profile associated with the UE 104 at the HSS 180 to disable one or more supplementary services which may interfere with a callback from the PSAP (e.g. by disabling SIP routing to one or more application server (AS) that implements such supplementary services). For example, in some embodiments, call forwarding may be disabled. In some embodiments, call blocking may be disabled. In some embodiments, simultaneous ringing will be disabled. Simultaneous ringing is a service in which multiple UE devices may ring at the same time. In some embodiments, sequential ringing may be disabled. Sequential ringing is a service in which multiple UE devices may be rung in sequence (i.e. they ring one after the other, in a sequence that may be defined according to user settings). In some embodiments, a do not disturb feature may be disabled. Do not disturb is a service which allows a UE 104 to reject any incoming call. In some embodiments, Anonymous call rejection may be disabled. Anonymous call rejection is a service in which a call to a UE device will be rejected if it has an anonymous calling identifier. In some embodiments, incoming call barring may be disabled. Incoming call barring is a service in which UE devices may bar all incoming calls. In some embodiments, dynamic black list may be disabled. Dynamic black list is a service in which a UE 104 device selectively rejects certain phone number on a blacklist.

The SMF 192 may not directly update the user profile associated with the UE. Instead, the SMF 192 sends a message to the HSS 180 to instruct the HSS to update the user profile associated with the UE, and the HSS 180 may then update the profile accordingly. That is, the SMF 192 instructs the HSS 180 to update the user profile associated with the UE 104 to disable a supplementary service (e.g. by disabling SIP routing to application server(s) implementing the supplementary service).

This message 192 may, in at least some embodiments, instruct the HSS to implement an emergency user profile for the user. More particularly, in some embodiments the HSS 180 may modify the IFC in the user profile to remove reference to one or more application server that implements the supplementary service(s) that interferes with emergency callback (e.g. this may be an AS that implements call forwarding, call blocking, simultaneous ringing and/or sequential ringing, for example). More particularly, IFC in the user profile are modified so that application servers associated with the supplementary service that may interfere with callback are removed from the IFC.

Since the set of enabled supplementary services may differ for different users (i.e. since one user profile may have a particular supplementary service enabled while another may not have that supplementary service enabled), after the HSS 180 receives the message from the SMF instructing the HSS to implement the emergency user profile (i.e. to ensure that the IFC does not cause communications to be routed to application servers that implement supplementary services that interfere with emergency callback), the HSS 180 determines whether the current user profile includes initial filter criteria directing messages to an AS that might interfere with callback from a PSAP (e.g. this may include determining whether a call forwarding AS is referenced in the IFC, whether a call blocking AS is referenced in the IFC, whether a simultaneous ringing AS is referenced in the IFC, whether a sequential ringing AS is referenced in the IFC, whether a do not disturb AS is referenced in the IFC, whether an Anonymous call rejection AS is referenced in the IFC, whether an incoming call barring AS is referenced in the IFC and/or whether a dynamic black list AS is referenced in the IFC). If the HSS determines that an AS which may interfere with emergency callback is referenced in the IFC, the AS that might interfere with callback is removed from the IFC.

The HSS 180 may store information about any modifications that are made to the user profile. That is, when a reference to an application server is removed from the IFC, the HSS 180 may store (in memory associated with the HSS), information which allows that reference to the application server to be re-inserted into the IFC at a later time. This information about modifications that are made to the user profile in order to implement an emergency profile may be stored in the user profile.

As noted above, after a predetermined period of time has elapsed (i.e. after the timer on the SMF has reached a predetermined period of time), the SMF 192 may re-enable the supplementary service. That is, the SMF 192 may cause the supplementary service that was disabled to be re-enabled. More particularly, the SMF 192 sends a message to the HSS 180 to instruct the HSS 180 to re-enable the supplementary service(s) that interfere with emergency callback.

As noted above, the HSS 180 stores information about the user profile that was active before the message (from the SMF 192) was received which caused the user profile to be updated to disable the supplementary service(s). For example, information that specifies the application server(s) that were formerly referenced in the IFC but which were removed from the IFC may be stored. This information allows the HSS 180 to revert back to the original user profile (i.e. to revert back to the IFC that included the AS that interferes with emergency callback) when the message instructing the HSS to re-enable the supplementary service(s) is received from the SMF 192.

Accordingly, after a predetermined period of time has elapsed, the SMF 192 may cause the HSS 180 to enable at least one supplementary service that was enabled before the emergency registration was received and that was disabled by the SMF 192 (by interacting with the HSS) when the emergency registration was detected.

It will be appreciated that the HSS may be comprised of memory (for storing user profiles) and an associated processor (for, among other things, enabling and disabling user profiles in accordance with messages received from the SMF 192 and/or when an emergency registration is detected). The HSS also includes one or more communication subsystems for communicating with other systems, devices and/or features, such as the SMF 192.

The network 100 may include other systems, subsystems and/or functions apart from those described herein. For example, in at least some embodiments, another access protocol, such as High Speed Packet Access (HSPA), may also allow a UE to access network services.

### Example System in Home Network Domain

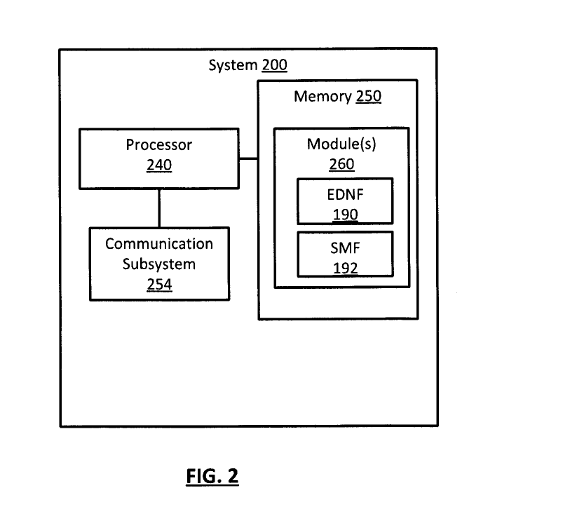

Referring now to FIG. 2, a block diagram of an example system 200 which may act as the SMF 192 and/or the EDNF 190 is illustrated. The system 200 operates in the home network domain 102 (FIG. 1) which, as noted above, also includes a home subscriber server (HSS) 180 which maintains user profiles associated with a plurality of communication devices (i.e. it maintains user profiles for a number of “subscribers” who may each be associated with at least one communication device (which may also be referred to as UE 104)).

The system 200 is configured to disable one or more supplementary services to allow call-back to user equipment (UE) 104 associated with an emergency. That is, the system 200 may disable one or more supplementary services that interfere with call-back to a communication device that placed an emergency call after the call was disconnected.

The system 200 includes one or more processors 240 coupled to other components, such as one or more communication subsystems 254 and one or more memory 250.

The communication subsystem 254 allows the system 200 to communicate with other systems. The other systems may, for example, implement functions of the network 100 (FIG. 1) that are not implemented on the system 200. For example, these other systems may include implement the HSS 180, the I-CSCF 182, the S-CSCF 184, the AS 181, the P-CSCF 158, or other functions that may or may not be illustrated in FIG. 1.

The example system implements the SMF 192 and the EDNF 190. Accordingly, the one or more processors 240 associated with the system 200 may be configured to perform the functions of the SMF 192 and/or the EDNF 190. More particularly, in at least some embodiments, the processor 240 may be associated with memory 250. The memory 250 may, in at least some embodiments, store non-transitory processor-executable instructions which configure the processor 240 to perform predetermined functions. These processor-executable instructions may be referred to as modules 260.

In the example embodiment, the modules 260 include the emergency detection and notification function 190 and the services modification function 192. These functions were described in greater detail above and will be described in further detail when the subsequent figures are discussed below. As noted in the discussion of FIG. 1 above, the EDNF 190 may cause the system 200 to detect an emergency registration. The emergency registration may, for example, be received via the communication subsystem 254 from another system (such as a system implementing the I-CSCF 182 or, if the system 200 of FIG. 2 also implements the I-CSCF 182, from a system implementing the P-CSCF 158). The EDNF 190 notifies the SMF 192 when the emergency registration is detected and the SMF 192 causes the HSS 180 to modify the user profile on the HSS for the user associated with the emergency registration to disable at least one supplementary service for the UE submitting the emergency registration. To modify the user profile, the SMF may communicate with another system which implements the HSS 180. Such communication may take place via a communication subsystem 254 of the system 200. Alternatively, in at least some embodiments, the SMF 192 and the HSS 180 may be provided on a common system 200. In such embodiments, the communication to the HSS may be performed on-device.

It will be appreciated that, while a single block is used in FIG. 2 to identify the memory 250, the memory 250 may, in fact, be comprised of a plurality of memory components, of different types. For example, as would be understood to a person skilled in the art, the memory 250 could include RAM, ROM, flash memory, a hard disk drive, or memory of another type. Different types of memory may be best suited for different purposed.

It will also be appreciated that, while FIG. 2 illustrates an embodiment in which the EDNF 190 and the SMF 192 are provided on a common system 200, these functions could be distributed onto multiple systems. For example, the EDNF 190 could be provided on a first system and the SMF 192 could be provided on a second system, and the first system and second system may be configured to communicate with one another through respective communication subsystems. Thus, the EDNF 190 and the SMF 192 could be associated with different processors and memory.

Furthermore, while FIG. 2 illustrates only the EDNF 190 and the SMF 192 implemented on the system, one or more of the other functions of the home network domain 102 may be implemented on the system 200. For example, in at least some embodiments, the HSS 180 may be implemented on the system 200. That is, a common system may implement both the HSS 180, the EDNF 190 and the SMF 192. Such a system may, for example, be referred to as the HSS 180. That is, the EDNF 190 and/or the SMF 192 may be provided on the system known as the HSS 180 which provides the HSS function described with respect to FIG. 1 above.

### Example Method of Disabling Supplementary Service to Allow Emergency Callback

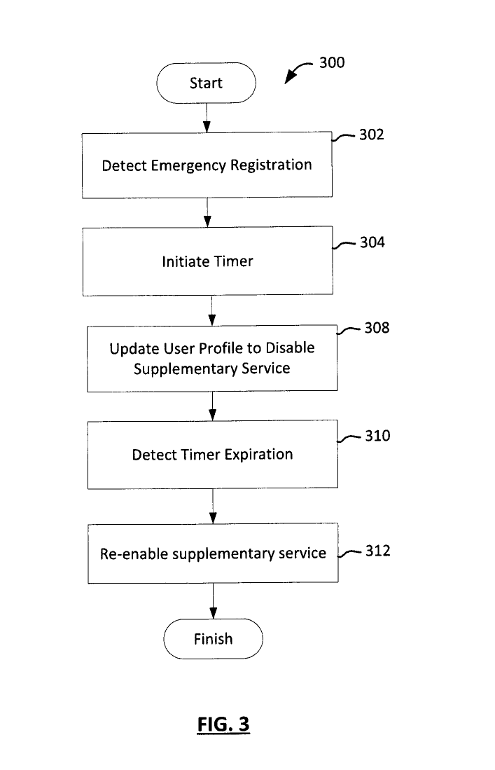

FIG. 3 is a flow chart depicting a method 300 which disables a supplementary service when an emergency call is placed from a UE 104. The method 300 may be performed by a system 200 (FIG. 2) that is associated with the network 100. More particularly, the method 300 may be performed by a system 200 (FIG. 2) operating in the home network domain 102 (FIG. 1) of a wireless network. As noted in the discussion of FIG. 1 above, the home network domain 102 includes a HSS 180 which maintains user profiles associated with a plurality of communication devices (which may also be referred to as UE). The user profiles define services enabled these communication devices. At least one of these user profiles may enable a supplementary service (e.g. by including IFC that cause messages to be routed to the application server that implements the supplementary service). A supplementary service is a service which is not a core service. Typically, the supplementary service provides some additional feature of benefit which enhances the core service, but the core service functions without the supplementary service. For example, voice communications may be considered a core service and features such as call forwarding or call blocking may be considered supplementary services.

The method of FIG. 3 may, for example, be performed by one or more systems 200 (FIG. 2) associated with an emergency detection and notification function 190 and a services modification function 192 and, or by an HSS 180. More particularly, processor-executable instructions (such as the emergency detection and notification function 190 and the services modification function 192, or other processor-executable instructions associated with an HSS) may configure an associated processor to perform the method 300.

At 302, an emergency registration associated with an emergency call placed from a communication device (also referred to as UE 104) is detected. As noted in the discussion of FIG. 1, the emergency registration originates at the UE 104 and passes to the home network domain 102 via the P-CSCF 158 operating in the serving network domain 101. Accordingly, in some situations the UE 104 may be roaming by communicating with a serving network domain 101 which is not the home network domain 102. When this happens, the emergency registration is, nevertheless, communicated to the home network domain 102. The emergency registration is passed to the home network domain 102 from the serving network domain 101 (or, more particularly, from a system operating in the serving network domain 101).

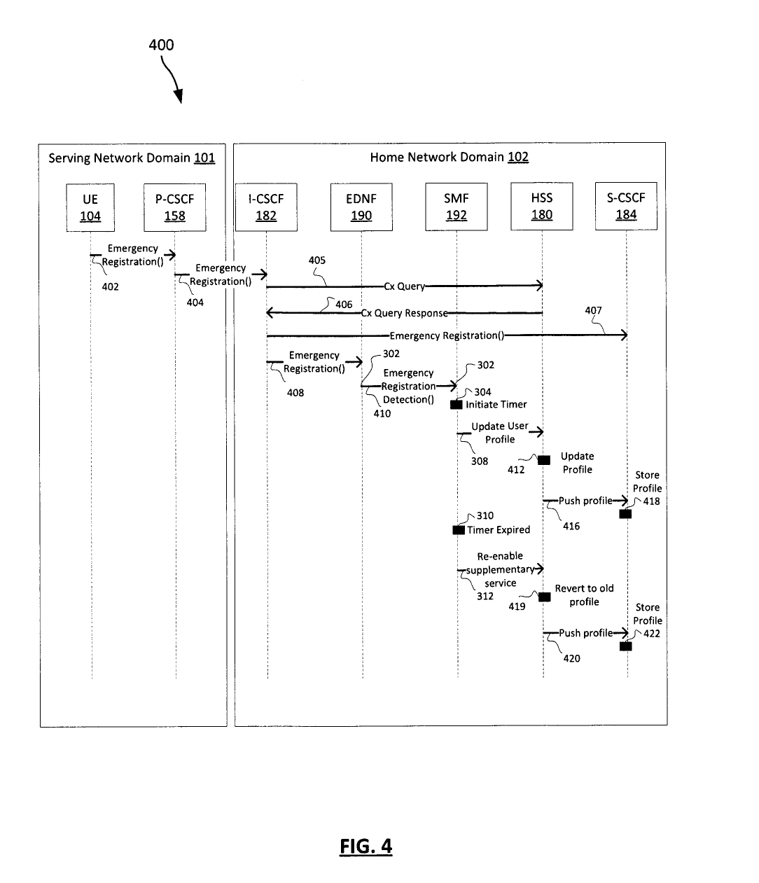

The specific manner by which the emergency registration is transmitted from the UE 104 to the home network domain 102 will be described in greater detail below with reference to the signalling diagram of FIG. 4.

The emergency registration is an Internet Protocol Multimedia Subsystem (IMS) emergency registration. The emergency registration is one that is configured to pass through the network 100 (FIG. 1) from the UE 104 to the home network domain 102. The emergency registration is produced, at least in part, in order to set up a call between the UE 104 and a PSAP 195, 197. More particularly, the use of an emergency registration for emergency call setup is defined in 3GPP specification TS 23.167 release 11. The use of the emergency registration for emergency call setup will be described in greater detail below in the discussion of signalling diagrams. However, as will be apparent from the discussion below, this emergency registration may be used for another purpose apart from emergency call setup—to disable a supplementary service that might interfere with callback from the PSAP to the UE if the call is disconnected.

The emergency registration is a signal that is associated with a particular UE 104. That is, the emergency registration is associated with the UE which sent the emergency registration signal. Thus, when the emergency registration is received at the EDNF 190, the EDNF is able to determine which UE 104 is associated with the emergency registration.

When the EDNF 190 detects the emergency registration, it may inform the SMF 192 that the emergency registration has been detected. Thus, the SMF 192 effectively detects the emergency registration when it is informed of the existence of the emergency registration by the EDNF 190. The SMF 192 is able to determine the UE 104 associated with the emergency registration in much the same way that this UE was identified by the EDNF.

At 304, in response to detecting the emergency registration, a timer may be initiated at the SMF 192.

Also in response to detecting the emergency registration, at 308, the user profile (at the HSS 180), which is associated with the communication device (i.e. the UE 104) that placed the emergency call is updated. More particularly, if a supplementary service is enabled for that UE 104 which will interfere with a possible callback from the PSAP, then that supplementary service may be disabled by the SMF 192. That is, the SMF 192 may cause the user profile for the subscriber associated with the UE placing the emergency call to disable the supplementary service (e.g. by altering the IFC such that SIP routing to the application server that performs the supplementary service is disabled).

As noted previously, in some cases, call forwarding may interfere with callback. Thus, in at least some embodiments, call forwarding may be the supplementary service that is disabled. Similarly, in at least some embodiments, call blocking may interfere with callback. Thus, in at least some embodiments, call blocking may be the supplementary service that is disabled. In some embodiments, simultaneous and/or sequential ringing may be disabled. In some embodiments, a do not disturb feature may be disabled. In some embodiments, Anonymous call rejection may be disabled. In some embodiments, incoming call barring may be disabled. In some embodiments, dynamic black list may be disabled. It will be appreciated that other supplementary services may interfere with callback and that any such supplementary services may also be disabled. It will also be appreciated that multiple supplementary services (such as both call blocking and call forwarding) may be disabled in some embodiments.

As noted in the discussion of FIG. 1 above, in at least some embodiments, the SMF 192 may not directly update the user profile associated with the UE. Instead, at 308 the SMF 192 sends a message to the HSS 180 to instruct the HSS to update the user profile associated with the UE, and the HSS 180 may then update the profile accordingly. That is, the SMF 192 instructs the HSS 180 to update the user profile associated with the UE 104 to disable a supplementary service. This message 192 may, in at least some embodiments, instruct the SMF to implement an alternate IFC in the user profile for the user.

More particularly, in some embodiments the HSS 180 may modify the IFC in the user profile to remove reference to one or more application server that implements the supplementary service(s) that interferes with emergency callback (e.g. this may be an AS that implements call forwarding, call blocking, simultaneous ringing, sequential ringing, do not disturb, anonymous call rejection, incoming call barring and/or dynamic black list, for example). More particularly, IFC in the user profile are modified so that application servers associated with the supplementary service that may interfere with callback are removed from the IFC.

Since the set of enabled supplementary services may differ for different users (i.e. since one user profile may have a particular supplementary service enabled while another may not have that supplementary service enabled), after the HSS 180 receives the message from the SMF instructing the HSS to implement the emergency user profile (i.e. to ensure that the IFC does not cause communications to be routed to application servers that implement supplementary services that interfere with emergency callback), the HSS 180 determines whether the current user profile includes initial filter criteria directing messages to an AS that might interfere with callback from a PSAP (e.g. this may include determining whether a call forwarding AS is referenced in the IFC, whether a call blocking AS is referenced in the IFC, whether a simultaneous ringing AS is reference in the IFC, whether a sequential ringing AS is referenced in the IFC, whether a do not disturb AS is referenced in the IFC, whether an Anonymous call rejection AS is referenced in the IFC, whether an incoming call barring AS is referenced in the IFC and/or whether a dynamic black list AS is referenced in the IFC). If the HSS determines that an AS which may interfere with emergency callback is referenced in the IFC, the AS that might interfere with callback is removed from the IFC.

The HSS 180 may store information about any modifications that are made to the user profile. That is, when a reference to an application server is removed from the IFC, the HSS 180 may store (in memory associated with the HSS), information which allows that reference to the application server to be re-inserted into the IFC at a later time. This information about modifications that are made to the user profile in order to implement an emergency profile may be stored in the user profile.

It will be appreciated that the features 304, 308 of the method 300 of FIG. 3 that are performed when an emergency registration is detected may have an order that is different than what is illustrated in FIG. 3. For example, the timer may be initiated after the user profile is updated.

As noted in the discussion of FIG. 1 above, the user profile effectively governs how the network 100 handles calls to a user. As noted above, the supplementary service may be implemented by a specific application server 181 which is specially configured to implement the supplementary service. A serving call session control function (S-CSCF) 184 (FIG. 1) is configured to receive a request to place a call to the communication device, and to, in response, retrieve the user profile associated with the call from the HSS. The S-CSCF 184 uses the application server which is configured to provide the supplementary service when the user profile indicates that the supplementary service is enabled for the communication device. However, it does not use the application server that provides the supplementary service when the user profile indicates that the supplementary service is not enabled for the communication device. Thus, the S-CSCF 184 may prevent the AS which provides the supplementary service from being engaged if the user profile indicates that the supplementary service is disabled.

Notably, by disabling the supplementary service, the supplementary service may be disabled for all incoming calls, irrespective of whether they are marked as emergency calls or not. Thus, using this technique, calls from a PSAP do not need to be specially marked as emergency calls. The supplementary service which prevents callback from the PSAP is disabled even when the incoming call (which may be from the PSAP) is not marked as an emergency call). This avoids any requirement for hardware or software modification at the PSAP.

In at least some embodiments, the supplementary service may not be disabled indefinitely. Rather, a supplementary service that was disabled at 308 may be re-enabled when certain criteria is satisfied. For example, the user profile for the communication device which placed the emergency call may be updated to re-enable the supplementary service that was disabled after the supplementary service was disabled for at least a predetermined period of time. More particularly, at 310, the SMF 192 may detect the expiration of the timer. This occurs when the timer (which was initiated at 304) reaches a predetermined threshold. When this happens, the supplementary service may be re-enabled (at 312). In at least some embodiments, in order to re-enable the supplementary service, the SMF 192 sends a message to the HSS to instruct the HSS 180 to re-enable the supplementary service. The HSS 180, upon receiving this message, may re-enable the supplementary service(s) that were disabled at 308. As noted above, in some embodiments, the HSS 180 is configured to store information about any modifications that are made to the user profile to implement an emergency user profile. That is, when a reference to an application server is removed from the IFC (at 308), the HSS 180 may store (in memory associated with the HSS), information which allows that reference to the application server to be re-inserted into the IFC at a later time. This information about modifications that are made to the user profile in order to implement an emergency profile may be stored in the user profile and may be used at 312 to reverse the changes made to the IFC at 308. That is, the reference to the application server removed from the IFC at 308 is included in the IFC once again.

This technique for disabling supplementary services in an emergency may be implemented wholly by the home network domain 102 without requiring modification to the UE, serving network domain 101 (assuming it is already configured to pass the emergency registration to the home network domain) and the PSAP. Since the solution is implemented at the home network domain 102, it may continue to function when the UE is in a roaming scenario (i.e. communicating with a serving network domain that is not the home network domain).

In at least some embodiments, the SMF 192 and/or the HSS 180 may be configured to allow the home network domain 102 to configure one or more settings associated with the SMF 192 and/or the HSS 180. For example, the SMF 192 may cause the system 200 which provides the SMF 192 to generate an emergency detection configuration user interface. This user interface may be displayed on a display associated with the system 200 and/or the HSS 180, or on a computer that logs in or otherwise connects to the system 200 and/or the HSS 180. In at least some embodiments, this user interface includes one or more interface element that enables the predetermined period of time associated with the timer of steps 304 and 310 to be adjusted. That is, the operator of the home network domain may specify the amount of time that the supplementary service should remain disabled following an emergency call. Upon receiving an input of a time via an associated input device (which may be used to interact with the user interface), this time may be stored in memory 250 associated with the system 200 so that it may be retrieved and used when 310 of the method 300 is performed. This setting may, for example, apply to all users of the home network domain 102.

Similarly, a user interface (which may be provided by the HSS 180, for example) may include an interface element that allows an operator associated with the home network domain 102 to identify the specific supplementary services that are to be disabled when an emergency call is detected. That is, the user interface may allow an operator associated with the home network domain to select one or more supplementary services that will be disabled in response to detecting the emergency registration. Upon receiving input selecting one or more supplementary services that are to be disabled in response to detecting the emergency registration, the HSS 180 may store an indication of the selected one or more supplementary services in memory associated with the system. This information may be relied upon, for example, when 308 of the method 300 is performed (e.g. in order to identify which application server references should be removed from the IFC).

The method 300 of disabling a supplementary service will now be described in greater detail with reference to the signal diagrams 400, 500, 600 of FIGS. 4, 5 and 6. Referring first to FIG. 4, a signal diagram 400 is illustrated with describes the signals associated with emergency registration and modification of the user profile.

At 402, an emergency registration signal is sent from user equipment 104 (also referred to herein as a communication device) to a P-CSCF 158. Both the UE 104 and the P-CSCF are in a serving network domain 101. The P-CSCF 158 sends, at 404, the emergency registration signal to an I-CSCF 182 associated with the home network domain 102 for that UE 104. The I-CSCF receives this signal and selects an appropriate S-CSCF 184 to forward the emergency registration to. To select the S-CSCF 184, the I-CSCF may send a query (at 405) to the HSS to request the HSS to identify the S-CSCF which should be engaged. More particularly, the I-CSCF is interested in determining which S-CSCF 184 should be engaged. A response to the query is received at 406 at the I-CSCF 182, and the I-CSCF uses the S-CSCF identified in the response. Thus, the I-CSCF forwards the emergency registration (at 406) to the S-CSCF 184.

The I-CSCF 182 also provides the emergency registration signal to the emergency detection and notification function (EDNF) 190 at 408. The EDNF detects the emergency registration (this may occur at 302 of the method 300 of FIG. 3) and sends a signal (at 410) to the services management function (SMF) 192 at 410. The SMF receives this signal and thus, itself, detects the emergency registration. Thus, 302 of the method 300 is also performed by the SMF 192.

The SMF 192 then initiates a timer at 304 in the manner described above with reference to FIG. 3. Then, at 308 the SMF 192 sends a signal to the HSS 180 updating the user profile for the UE 104 which initially sent the emergency registration signal at 402. The signal sent to the HSS 180 causes that user profile to be modified to disable at least one supplementary service (i.e. a supplementary service that has a negative impact on PSAP callback). More particularly, as described with reference to 308 of the method 300 of FIG. 3, a service that interferes with a callback is disabled by modifying the IFC in the user profile to remove one or more application servers which implement the supplementary service being removed.

As noted above, the SMF 192 may not directly update the user profile associated with the UE. Instead, the SMF 192 sends a message to the HSS 180 (which is included in the signal sent at 308 of FIG. 4) to instruct the HSS to update the user profile associated with the UE, and the HSS 180 may then update the profile accordingly. That is, the SMF 192 instructs the HSS 180 to update the user profile associated with the UE 104 to disable a supplementary service. This message 192 may, in at least some embodiments, instruct the SMF to implement an emergency user profile for the user by modifying the IFC to remove an application service that implements a supplementary service that may interfere with emergency callback.

After the active user profile has been updated (at 412) to disables one or more supplementary services (e.g. by updating the IFC as described above), the updated user profile may be pushed (i.e. automatically sent), at 416, to the S-CSCF 184. More particularly, a Push-Profile-Request (PPR) may be sent to the S-CSCF 184. The updated user profile is received at the S-CSCF 184 and is stored in memory associated with the S-CSCF 184 at 418.

The timer may then expire at the SMF 192 at 310 (i.e. when the time reached a predetermined period of time), which causes the SMF to send a signal to the HSS 180 at 312 to re-enable the supplementary service that was disabled. In response to receiving this signal, the HSS 180 (at 419) reverts back to a non-emergency user profile associated with the UE 104. That is, the HSS 180 re-introduces the application server(s) that were removed from the IFC back into the IFC.

After the active user profile has been updated (at 419) so that the IFC again includes the application servers (AS) which interfere with emergency callback, the updated user profile may be pushed (i.e. automatically sent), at 420, to the S-CSCF 184. More particularly, a Push-Profile-Request (PPR) may be sent to the S-CSCF 184. The updated user profile is received at the S-CSCF 184 and is stored in memory associated with the S-CSCF 184 at 422.

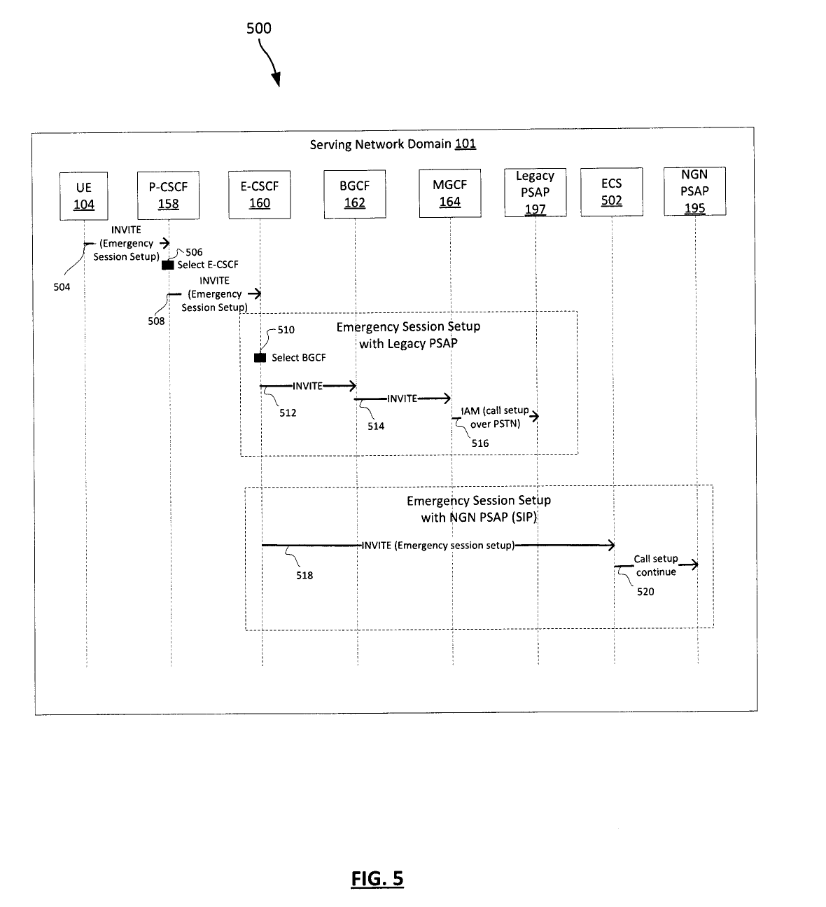

Referring now to FIG. 5, an example of another signal diagram 500 which illustrates the call setup procedure is illustrated. This procedure is performed after the emergency registration is sent from the UE 104 and after the UE 104 has received a signal back from the network confirming the registration of the emergency call. The signal diagram 500 of FIG. 5 illustrates steps that are performed in the serving network domain 101.

At 504, an INVITE to an emergency session is sent from the UE 104 to the P-CSCF 158. Upon receiving this INVITE, the P-CSCF 158 may (at 506) select an appropriate E-CSCF 160. The E-CSCF 160 may, for example, be selected based on the location of the UE 104. In such cases, the P-CSCF may query a location register function (LRF) (not shown) to identify the location of the UE 104.

At 508, the INVITE to the emergency session is sent from the P-CSCF 158 to the selected E-CSCF 160. The invite is received at the E-CSCF 160. At this point the E-CSCF 160 may operate differently depending on whether it is dealing with a legacy PSAP 197 or an NGN PSAP 195. If the PSAP is a legacy PSAP, a BGCF 162 may be selected (at 510) based on the location of the UE 104 and, at 512, the INVITE may be sent to that BGCF 162. Then, at 514, the INVITE may be forwarded to an MGCF 164 and the call may be setup over the PSTN with the legacy PSAP 197 when INVITE is forwarded from the M6CF 164 to the legacy PSAP 197 at 516.

If, however, the PSAP is a NSN PSAP, then the E-CSCF 160 may send an INVITE to the emergency session to the emergency call service (ECS) 518. At 520, the ECS 502 allows the call setup to continue with the NGN PSAP 195.

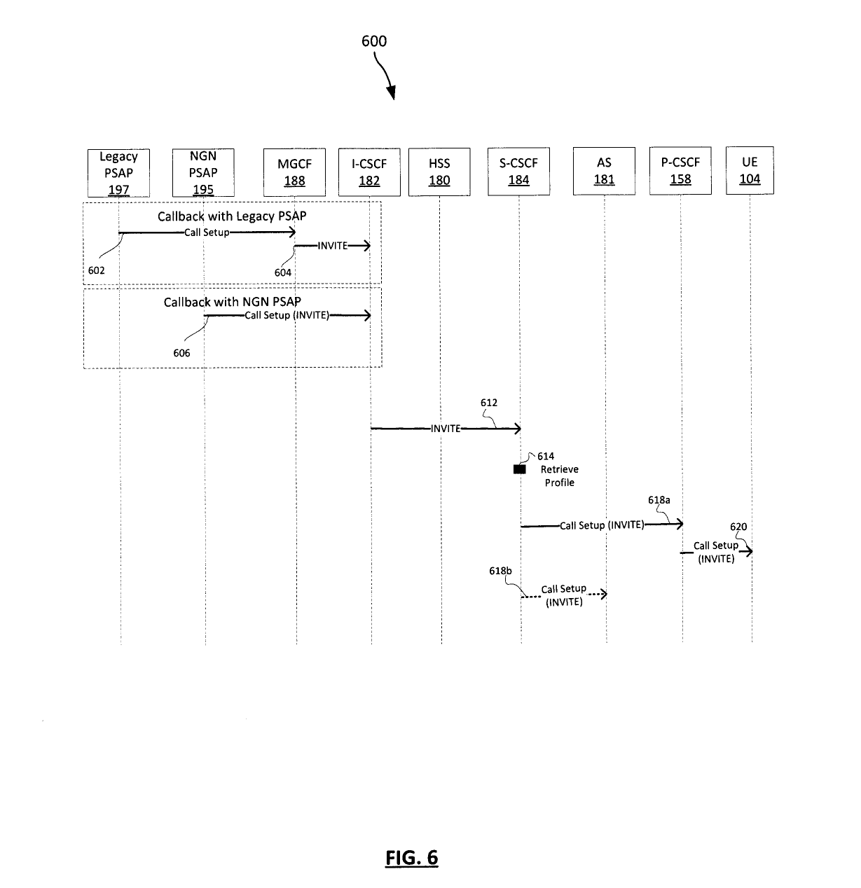

At some point after the call has been setup, the call may be disconnected. This may happen for any one of a number of different reasons, including, for example, loss of wireless coverage at the UE 104, the nature of the emergency has caused the call to be disconnected or caused the user to hang up the call, etc. At this point, the PSAP (which may be a legacy PSAP 197 or an NGN PSAP 195) may wish to call back the UE 104. Referring now to FIG. 6, an example of a signal diagram 600 of such a call back scenario is illustrated.

If the PSAP is a legacy PSAP 197, at 602, the legacy PSAP 197 sends a call setup signal to the MGCF 188 in the home network domain 102 for the UE 104. The MGCF 188 then provides an INVITE to the I-CSCF 182 (also in the home network domain 102) to attempt to invite the UE 104 to a call session.

Alternatively, if the PSAP is a NGN PSAP 195, then the call setup signal (i.e. the SIP invite) may be sent directly from the NGN PSAP 195 to the I-CSCF 182 (i.e. the MGCF 188 is not engaged) at 606.

After the INVITE is received at the I-CSCF, the INVITE is then sent from the I-CSCF to the S-CSCF (which was assigned after successful registration) at 612.

At this point, the S-CSCF 184 retrieves the user profile for the UE 104 from memory. The user profile allows the S-CSF 184 to determine how to handle the call.

The user profile retrieved from memory may be an emergency user profile (received at 416 of FIG. 4) or a non-emergency user profile (such as the emergency user profile received at 420 of FIG. 4). More particularly, the user profile may either contain IFC which causes SIP messages to be routed to an application server (AS) that may interfere with emergency callback (in which case it may be considered to be a non-emergency user profile), or it may contain a user profile that contains IFC which do not cause SIP messages to be routed to such application servers (in which case it may be considered to be an emergency user profile). The S-CSCF 184 acts differently depending on the contents of the user profile. If the user profile indicates that a supplementary service has been disabled (i.e. if it is an emergency user profile which contains IFC that avoids the application server implementing the supplementary service), then an application server 181 that executes that supplementary service may not be engaged. Instead, the call setup invitation is sent to the P-CSCF 158 without engaging that application server 181 (at 618a). This invitation is sent to the UE 104 from the P-CSCF 158 at 620. Accordingly, if the user profile indicates that a supplementary service is disabled, then the SIP flow may be different than if the user profile indicates that the supplementary service is enabled; an application server that hosts the unwanted supplementary service may be skipped if the supplementary service is disabled.

Thus, it may be seen how the steps of the method 300 of FIG. 3 and the signals of the signal diagram 400 of FIG. 4 allow a supplementary service to be disabled so that an emergency callback is not interrupted due to the use of such a supplementary service.

To further illustrate this point, an example of a signal that might be sent if the supplementary service was not disabled in the user profile is illustrated using numeral 618b (i.e. if the user profile that is currently active and that was retrieved from memory is a non-emergency user profile which has IFC that cause messages to be routed to an application server that may interfere with emergency callback from a PSAP). This signal represents an alternative to the signal sent at 618a; it is sent if the user profile does not indicate that the supplementary service is disabled. More specifically, at 618b the S-CSCF 184 sends the invitation for a call setup to the application server 181 which implements the supplementary service. If, for example, the supplementary service is call forwarding, then the call does not reach the UE 104. Instead, the call may be directed to a different UE.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method, performed by a system operating in a home network domain of a wireless network, the home network domain including a home subscriber server (HSS) which maintains user profiles associated with a plurality of communication devices, the user profiles defining services enabled for such communication devices, the method comprising:
detecting an emergency registration associated with an emergency call placed from the communication device; and
in response to detecting the emergency registration associated with the emergency call, updating, at the HSS, the user profile associated with the communication device which placed the emergency call to disable at least one supplementary service for that communication device.

2. The method of claim 1, wherein the supplementary service is a call forwarding service.

3. The method of claim 1, wherein the supplementary service is a call blocking service.

4. The method of claim 1, wherein the supplementary service is a simultaneous ringing service or a sequential ringing service.

5. The method of claim 1, further comprising:
updating the user profile for the communication device which placed the emergency call to re-enable the supplementary service after the supplementary service has been disabled for at least a predetermined period of time.

6. The method of claim 4, further comprising, prior to detecting:
generating an emergency detection configuration user interface, the emergency detection configuration user interface including one or more interface elements that enable the predetermined period of time to be input;
receiving an input of the predetermined period of time; and
storing the predetermined period of time in memory associated with the system.

7. The method of claim 1, wherein updating the user profile associated with the communication device comprises:
sending an instruction to the HSS to instruct the HSS to update initial filter criteria in the user profile to remove an application server associated with the supplementary service.

8. The method of claim 1, further comprising, prior to detecting:
generating an emergency detection configuration user interface, the emergency detection configuration user interface including one or more interface elements that allow an operator associated with the home network domain to select one or more supplementary services that will be disabled in response to detecting the emergency registration;
receiving input selecting one or more supplementary services to be disabled in response to detecting the emergency registration; and
storing an indication of the selected one or more supplementary services in memory associated with the system.

9. The method of claim 1, wherein the emergency registration is an Internet Protocol Multimedia Subsystem (IMS) emergency registration.

10. The method of claim 1, wherein the system operating in the home network domain is the HSS.

11. The method of claim 1, wherein the supplementary service is implemented by an application server, and wherein a serving call session control function (S-CSCF) is configured to receive a request to place a call to the communication device, to retrieve the user profile associated with the call, and to use the application server to provide the supplementary service when the user profile indicates that the supplementary service is enabled for the communication device but to not use the application server to provide the supplementary service when the user profile indicates that the supplementary service is not enabled for the communication device.

12. The method of claim 11, wherein the request to place a call to the communication device is not marked as an emergency call.

13. The method of claim 1, wherein the emergency registration is received at the home network domain via a serving network domain, and wherein the communication device is roaming by communicating with the serving network domain which is not the home network domain for that communication device.

14. A system for disabling one or more supplementary services to allow call-back to a communication device associated with an emergency, the system comprising:
one or more communication subsystems enabling the system to receive communications from other systems;
at least one processor coupled with the communication subsystem; and
at least one memory coupled with the processor, the at least one memory storing processor executable instructions which, when executed, causes the at least one processor to:
detect an emergency registration associated with an emergency call placed from the communication device; and
in response to detecting the emergency registration associated with the emergency call, updating at a home subscriber server (HSS), the user profile associated with the communication device which placed the emergency call to disable at least one supplementary service for that communication device.

15. The system of claim 14, wherein the supplementary service is a call forwarding service.

16. The system of claim 14, wherein the supplementary service is a call blocking service.

17. The system of claim 14, wherein the processor is further configured to:
update the user profile for the communication device which placed the emergency call to re-enable the supplementary service after the supplementary service has been disabled for at least a predetermined period of time.

18. The system of claim 17 wherein the processor is further configured to, prior to detecting:
generate an emergency detection configuration user interface, the emergency detection configuration user interface including one or more interface elements that enable the predetermined period of time to be input;
receive an input of the predetermined period of time; and
store the predetermined period of time in memory associated with the system.

19. The system of claim 14, wherein updating the user profile associated with the communication device comprises:
sending an instruction to the HSS to instruct the HSS to update initial filter criteria in the user profile to remove an application server associated with the supplementary service.

20. The system of claim 14, wherein the emergency registration is an Internet Protocol Multimedia Subsystem (IMS) emergency registration.
